(19) United States
(12) Patent Application Publication
(10) Pub. No.: US 2024/0342877 A1
(43) Pub. Date: Oct. 17, 2024

(54) Method for Controlling a Hand-Held Power Tool

(71) Applicant: Robert Bosch GmbH, Stuttgart (DE)

(72) Inventors: Markus Traub, Oppenweiler (DE); Achim Wurst, Murrhardt (DE); Jessica Hanselmann, Ruppertshofen (DE); Markus Leupert, Murrhardt (DE); Thomas Gabriel, Kirchheim-Jesingen (DE); Stefan Horstmann, Leinfelden-Echterdingen (DE)

(21) Appl. No.: 18/292,233

(22) PCT Filed: Jul. 27, 2022
(86) PCT No.: PCT/EP2022/071091

§ 371 Date: Jan. 25, 2024

(30) Foreign Application Priority Data
Aug. 9, 2021 (DE) 10 2021 208 653.5

(51) Int. Cl. B25B 23/147; B25B 21/02

(52) U.S. Cl. CPC B25B 23/147; B25B 21/02

(57) ABSTRACT

A method is disclosed for controlling a hand-held power tool, in particular a cut-off screwdriver, the hand-held power tool including a drive motor and a control unit. The method includes (i) setting an operating stage for controlling the drive motor by way of the control unit, wherein the operating stage includes a direction of rotation of the drive motor, a rotational speed of the drive motor, and a cut-off criterion, (ii) setting a rotational speed constancy of the rotational speed of the drive motor, (iii) operating the drive motor depending on set operating stage and/or the set rotational speed constancy, and (iv) braking the drive motor when the cut-off criterion is met.

The present invention relates to a method for controlling a hand-held power tool according to claim 1.

### THE PRIOR ART

DE 10 2011 056 269 A1 discloses a method and a device for mechanically tightening screw connections by means of an open tongue tool.

### DISCLOSURE OF THE INVENTION

The present invention describes a method for controlling a hand-held power tool, in particular a cut-off screwdriver, the hand-held power tool comprising a drive motor and a control unit, and the method comprising the following method steps:
setting an operating stage for controlling the drive motor by means of the control unit, the operating stage comprising a direction of rotation of the drive motor, a rotational speed of the drive motor, and a cut-off criterion,
setting a rotational speed constancy of the rotational speed of the drive motor,
operating the drive motor depending on the set operating stage and/or the set rotational speed constancy,
braking the drive motor when the cut-off criterion is met.

One disadvantage of the prior art is that known hand-held power tools, in particular cut-off screwdrivers, can only be operated at a maximum motor speed. The present invention solves this problem.

The invention provides a method for controlling a hand-held power tool, by means of which method the rotational speed constancy can be adjusted such that the quality of screw connections can be increased.

The hand-held power tool can be designed as an electrically or pneumatically operated hand-held power tool. The electrically operated hand-held power tool can in this case be designed as a grid-powered or battery-driven hand-held power tool. The hand-held power tool can be designed as a screwdriver, a pneumatic screwdriver, a drill screwdriver, a rotary impact screwdriver, a pneumatic rotary impact screwdriver, an impact drill screwdriver, or a cut-off screwdriver. Cut-off screwdrivers are known from DE 103 41 974 A1 and have industrial uses, especially in the automotive industry, in order to produce screw connections with a predetermined tightening torque. Such a cut-off screwdriver is, e.g., also disclosed in DE 44 30 186 A1, for which reason it is not discussed in more detail herein.

The hand-held power tool comprises a drive unit having the drive motor and having at least one transmission. The drive motor can be designed as an electric motor. The transmission can be designed as one planetary gear, in which case it can, for example, be shiftable. The invention can also be applied to other types of motors or transmissions. The hand-held power tool further comprises an energy supply, whereby the energy supply is provided for battery-driven operation by means of rechargeable batteries, in particular hand-held power tool rechargeable battery packs, and/or provided for grid operation. In a preferred embodiment, the energy supply is designed for battery-driven operation. In the context of the present invention, the expression “hand-held power tool rechargeable battery pack” is understood to mean a combination of at least one rechargeable battery cell and a rechargeable battery pack housing. The hand-held power tool rechargeable battery pack is advantageously designed for supplying energy to commonly available battery-driven hand-held power tools. The at least one rechargeable battery cell can, for instance, be designed as a Li-ion rechargeable battery cell having a nominal voltage of 3.6 V. The hand-held power tool rechargeable battery pack can, e.g., comprise up to ten rechargeable battery cells, whereby a different number of rechargeable battery cells also is conceivable. Both an embodiment as a battery-driven hand-held power tool and operation as a grid-powered hand-held power tool are sufficiently well-known to the skilled person, so the specifics of the energy supply will not be addressed herein.

The drive unit is designed such that it can be actuated via a manual switch. When the manual switch is actuated by a user, then the drive unit is switched on and the hand-held power tool is put into operation. If the manual switch is not further actuated by the user, then the drive unit is switched off. Preferably, the drive unit can be electronically controlled and/or regulated such that a reversing operation can be achieved. It is also conceivable that the manual switch is a latching manual switch that can be latched in at least one position during at least one actuation state. In particular, the manual switch is designed such that the method is performed as soon as a user actuates the manual switch.

The hand-held power tool can comprise a percussion mechanism. During operation, the percussion mechanism generates high torque peaks in order to free stuck connecting means or to attach connecting means. The percussion mechanism can be connected to the drive motor by way of the transmission. The percussion mechanism can, e.g., be designed as a rotary percussion mechanism, a detent percussion mechanism, a rotary percussion mechanism, or a hammer mechanism. In addition, the percussion mechanism can be connected to an output shaft.

A tool holder is formed at a free end of the output shaft, in particular in a direction pointing away from the drive unit. The tool holder can be designed as an internal tool holder and/or as an external tool holder. For example, the internal tool holder can be designed as a polygonal internal holder for connection to an insert tool. The polygonal internal holder can, e.g., be designed as an internal hexagon mount so that the insert tool can, e.g., be held in the form of a screwdriver bit. For example, the outer tool holder can be designed as a polygonal outer holder for connection to an insert tool. The polygonal external mount can, e.g., be designed as an external square mount, so that the insert tool can, e.g., be held in the form of a screwdriver bit. Such a screwdriver bit and such a screw socket are sufficiently known from the prior art, so a detailed description is omitted herein.

The hand-held power tool, in particular the drive unit, can comprise a clutch. The clutch is designed to disconnect the tool holder from the transmission and/or from the drive motor as soon as an adjustable torque rests against the tool holder. The clutch can be arranged between the tool holder and the percussion mechanism, between the tool holder and the transmission, or between the percussion mechanism and the transmission. The clutch can, e.g., be designed as a cut-off clutch, an overload clutch, or a torque clutch.

The hand-held power tool features at least one tool axis. The tool axis can, e.g., be designed as an axis of rotation of the output shaft or the tool holder. The term “axial” is in particular understood to mean essentially parallel to the tool axis. In contrast, the term “radial” is understood to mean essentially perpendicular to the tool axis.

The control unit of the hand-held power tool is designed to control and/or regulate the drive unit, in particular the drive motor. In particular, the control unit is designed such that the method is performed as soon as the user actuates the manual switch.

The operating stage for controlling the drive motor comprises the direction of rotation of the drive motor, the rotational speed of the drive motor, and the cut-off criterion. The operating stage is set using the control unit. The direction of rotation of the drive motor can, e.g., be a loosening direction of rotation, e.g. a left-hand direction of rotation for fastening elements with a right-hand thread or a right-hand direction of rotation for fastening elements with a left-hand thread, or a tightening direction of rotation, e.g. a right-hand direction of rotation for fastening elements with a right-hand thread or a left-hand direction of rotation for fastening elements with a left-hand thread. Recourse fastening elements can, e.g., be screws, self-tapping screws, nuts, or self-locking nuts. The direction of rotation can be set for the operating stage so that, for a plurality of operating stages, the direction of rotation can be set for each individual operating stage. The rotational speed of the drive motor can in this case be a rotational speed of an output shaft of the drive motor. The rotational speed of the drive motor can be set for the operating stage so that the rotational speed can be set separately for each of the plurality of operating stages. The cut-off criterion is set by the control unit. The cut-off criterion in this case comprises a criterion at which the hand-held power tool, in particular the cut-off screwdriver, switches off. The cut-off criterion can be set for the operating stage, so that an independent cut-off criterion can be set for each individual operating stage for the plurality of operating stages. Possible cut-off criteria can, e.g., include reaching a number of revolutions of the drive motor, in particular the output shaft, revolutions of the output shaft, revolutions of the tool holder, an angle of rotation of the drive motor, in particular the output shaft, an angle of rotation of the pinion shaft, an angle of rotation of the tool holder, a battery voltage of the hand-held power tool rechargeable battery pack falls below a definable value, a cut-off torque is reached at the output shaft and/or the tool holder, an external signal, e.g. from an overload clutch, an elapsed time, fault conditions occurring in the hand-held power tool, in particular the cut-off screwdriver and/or accelerations occurring, e.g. 0 G, a multiple of 1 G, or high, recurring angular accelerations.

The control unit is designed to set the rotational speed constancy of the rotational speed of the drive motor. The rotational speed constancy is in this case a characteristic of the rotational speed of the drive motor. The control unit is further designed to operate the drive motor depending on the set operating stage and/or the set rotational speed constancy. As soon as the user actuates the manual switch, the drive motor is operated at the set operating stage and/or the set rotational speed constancy. In addition, the plurality of operating stages can be performed as soon as the user actuates the manual switch.

The control unit is designed to brake the drive motor once the cut-off criterion is met. When the cut-off criterion is reached, the drive motor is braked even if the user continues to hold down the manual switch. Typically, the method is only repeated when the user releases the manual switch and presses it again. The control unit can enable braking of the drive motor by means of, e.g., short-circuit braking and/or counter-current braking. In short-circuit braking, an electric field is applied to the drive motor in order to force the drive motor to brake. In counter-current braking, an electric field is applied in the opposite direction of rotation of the drive motor in order to brake the drive motor. It is conceivable that the drive motor is switched off before braking. As soon as the drive motor is switched off, it is de-energized and can run down so that the drive motor can still perform at least one partial revolution. For example, rapid braking of the drive motor can be made possible by a combination of switching off the drive motor with short-circuit braking and/or counter-current braking.

The method for controlling the hand-held power tool, in particular the cut-off screwdriver, can be set by means of a program, in particular a computer program, or an app on an external computing unit, e.g. a computer, a server, a smartphone, or the like. The operating stage and the rotational speed constancy can in this case be set in the program. The program can also set the plurality of operating stages. The program enables the direction of rotation of the drive motor, the rotational speed of the drive motor, and the cut-off criterion to be set for each operating stage. The program also enables the rotational speed constancy to be set for each operating stage. Subsequently, the set method for controlling the hand-held power tool, in particular the cut-off screwdriver, can be transmitted from the program to the hand-held power tool, in particular the cut-off screwdriver, in a wired and/or wireless manner. The hand-held power tool, in particular the cut-off screwdriver, can receive the control method and transmit it to the control unit. The wired transmission of the control method can, e.g., be transmitted from the external computing unit to the hand-held power tool, in particular the cut-off screwdriver, by means of a USB cable. For this purpose, the external computing unit and the hand-held power tool, in particular the cut-off screwdriver, comprise at least one USB interface. The wireless transmission of the control method can, e.g., be performed by means of a wireless connection, e.g. a Bluetooth, Wi-Fi and/or NFC connection, between the external computing unit and the hand-held power tool, in particular the cut-off screwdriver.

In one embodiment of the method, the rotational speed is an essentially constant rotational speed when the rotational speed constancy is activated. The rotational speed constancy can be set for each operating stage using the program. The essentially constant rotational speed can be in a range from 2,400 l/min to 24,000 l/min. The output speed can change depending on the gear ratio. The rotational speed constancy can in this case be ensured without a load being applied to the tool holder. The rotational speed constancy can in this case feature a rotational speed fluctuation around the set rotational speed in the range of 10%.

In one embodiment of the method, the rotational speed is a maximum rotational speed when the rotational speed constancy is deactivated. The maximum rotational speed is in this case the maximum speed of the drive motor. The maximum rotational speed in this case depends on the current battery voltage of the hand-held power tool rechargeable battery pack. As a result, no dependency exists between the maximum available rotational speed and the current battery voltage. If the battery voltage drops, the maximum rotational speed can decrease. The maximum rotational speed can be in the range from 9,000 l/min to 30,000 l/min, in particular from 10,000 l/min to 27,000 l/min. A maximum output speed can depend on a gear ratio. The maximum rotational speed can be set individually for each operating stage.

In one embodiment, the method comprises detecting a current rotational speed of the drive motor using the control unit and comparing the current rotational speed with the rotational speed. The control unit is designed to detect the current rotational speed of the drive motor. For this purpose, the hand-held power tool, in particular the cut-off screwdriver, can comprise Hall sensors which are designed to determine the current rotational speed of the drive motor. The control unit is further designed to compare the current rotational speed with the set rotational speed. The control unit in this case compares the current rotational speed with the (in particular set) rotational speed. The control unit can in this case compare the current rotational speed with the rotational speed within a chronological range around 1 ms.

In one embodiment of the method, the current rotational speed is regulated using the control unit if the comparison results in a deviation from the current rotational speed to the rotational speed. The control unit is designed to regulate the current rotational speed in the event of the deviation such that the rotational speed, in particular the set rotational speed, is detected. The control unit can thereby increase the current rotational speed if the current rotational speed is below the speed, in particular the set speed. The control unit can also reduce the current rotational speed if the current rotational speed is above the speed, in particular the set speed. For example, the control unit can regulate the current rotational speed if the deviation is greater than 10% from the set rotational speed. The control unit can in this case regulate the current rotational speed until the deviation is less than or equal to 10% of the set rotational speed.

In one embodiment, the method comprises one method step:
receiving an operating stage from an external communication device using the control unit.
   The method step of receiving the operating stage can be an upstream method step, so receiving the operating stage can be performed before the method step of setting the operating stage. The operating stage can be received by the external communication device, e.g. the external computing unit, in a wired and/or wireless manner. It can, e.g., be sufficient for the operating stage to be received essentially once and for the control unit to store the method steps. As a result, the hand-held power tool, in particular the cut-off screwdriver, is able to receive a further operating stage only when a different operating stage is requested by the user. Wired and/or wireless reception can be performed, as described hereinabove.

In one embodiment, the method comprises one method step:
transmitting screw connection information when the cut-off criterion is reached.
   The method step of transmitting the screw connection information can be performed before the drive motor is braked or after the drive motor is braked. The screw connection information can in this case comprise information regarding whether a screw connection is or is not satisfactory. The hand-held power tool, in particular the cut-off screwdriver, can comprise an output unit for outputting the screw connection information. The output unit can, e.g., output the screw connection information acoustically, visually, and/or haptically. The output unit can, e.g., be designed as an HMI. It is therefore conceivable that a satisfactory screw connection is indicated by the illumination of a green LED. It is also conceivable that an unsatisfactory screw connection is indicated by the illumination of a red LED along with an acoustic warning signal.

In one embodiment, the method comprises one method step:
determining a battery voltage of a hand-held power tool rechargeable battery pack of the hand-held power tool by means of the control unit.
   During operation of the hand-held power tool, in particular the cut-off screwdriver, the hand-held power tool rechargeable battery pack is connected to the hand-held power tool, in particular the cut-off screwdriver, so that the hand-held power tool rechargeable battery pack supplies the hand-held power tool with electrical energy. The control unit is designed to determine the battery voltage during operation of the hand-held power tool. The control unit can in this case determine the battery voltage several times during the method. The battery voltage can then be used as an additional parameter for performing the method. The maximum rotational speed depends on the battery voltage. The lower the battery voltage, the lower the maximum rotational speed.

In one embodiment, the method comprises comparing the battery voltage with a battery voltage limit value and transmitting a number of screw connections if the battery voltage falls below the battery voltage limit value. The control unit is designed to compare the determined battery voltage with the battery voltage limit value if the battery voltage falls below the battery voltage limit value. The battery voltage limit value can, e.g., be set in the program on the external computing unit or be preset at the factory. The control unit is also designed to determine a remaining number of screw connections by comparing the battery voltage with the battery voltage limit value. The control unit can then transmit the remaining number of screw connections to the user as the number of screw connections, e.g. using the output unit. The output unit can, e.g., then indicate that ten successful screwdriving operations are still possible before the hand-held power tool, in particular the cut-off screwdriver, switches off. However, a different number of successful screwdriving operations is also possible if the battery voltage falls below the battery voltage limit.

In one embodiment, the method comprises comparing the battery voltage to a minimum battery voltage until the battery voltage falls below the minimum battery voltage as the cut-off criterion. The control unit is designed to compare the battery voltage with the minimum battery voltage. The minimum battery voltage can be set using the program or at the factory. If the control unit determines that the battery voltage falls below the minimum battery voltage limit, then the control unit can set a shutdown, in particular braking, as the cut-off criterion. The control unit is also designed such that it prevents further screwdriving if the control unit determines that further screwdriving cannot be successfully completed.

In one embodiment of the method, the operating stage comprises a threading stage. In the threading stage, at least a fraction of a turn is performed in a loosening direction of rotation. The fraction of a revolution can, e.g., be a few angular degrees of revolution, a quarter of a revolution, half a revolution, three quarters of a revolution, or a whole revolution. The fraction of a revolution can in this case be performed by the drive motor, in particular the output shaft, the transmission, the output shaft, and/or the tool holder. It is also conceivable that more than the fraction of a revolution is performed in the loosening direction of rotation. As described hereinabove, the loosening direction of rotation can be a counterclockwise or clockwise direction of rotation. The threading stage can be set using the program so that a threading speed, the loosening direction of rotation, and the threading cut-off criterion can be set for the threading stage. The rotational speed constancy can be set for the threading stage.

In one embodiment of the method, the operating stage comprises a high-speed rotation stage, wherein in the high-speed rotation stage, a high-speed rotation stage number of revolutions is performed in a tightening direction at a high-speed rotation stage speed. The high-speed rotation stage can be set using the program. The high-speed rotation stage can follow the threading stage. The high-speed rotation stage comprises the high-speed rotation stage speed, the tightening direction and, as the cut-off criterion, the high-speed rotation stage number of revolutions. The high-speed rotation stage number in this case depends on the length of the fastening element and/or the number of threads. Regarding the high-speed rotation stage speed, the rotational speed constancy can be activated or the maximum rotational speed can be set. As described hereinabove, the tightening direction can be clockwise or counterclockwise. It is conceivable that the high-speed rotation stage is performed as an optional method step.

In one embodiment of the method, the operating stage comprises a cut-off stage, whereby, during the cut-off stage a cut-off stage rotational speed is performed in a tightening direction of rotation until a cut-off torque is reached as the cut-off criterion. The cut-off stage can be set using the program. The cut-off stage can follow the threading stage and/or the high-speed rotation stage. The cut-off stage comprises the cut-off stage rotational speed, the tightening direction, and the cut-off torque as the cut-off criteria. The rotational speed constancy or the maximum rotational speed can be set for the cut-off stage rotational speed. The cut-off stage rotational speed can in this case depend on the application and can, e.g., be in the range from 50 l/min to 3000 l/min. The cut-off stage rotational speed can in this case be applied to the output shaft and/or tool holder. The cut-off torque can, e.g., be determined by at least one disengagement of the overload clutch. Reference is in this context made to DE 10 2016 220 001 A1 and DE 10 2012 204 172 A1 regarding the detection of over-engagement of the overload clutch. The drive motor is braked as soon as the control unit detects the one-time disengagement of the overload clutch. As described hereinabove, the tightening direction can be clockwise or counterclockwise.

In one embodiment of the method, the operating stage comprises a loosening stage, wherein a loosening stage number of revolutions is performed in one loosening direction of rotation during the loosening stage. The loosening stage can be set using the program. The loosening stage can follow the cut-off stage. The loosening stage can be used to prevent the fastening element from settling and/or to enable a fastening support, e.g. a vehicle door, to be aligned. The loosening stage comprises a loosening stage rotational speed, the loosening direction of rotation and, as a cut-off criterion, the number of rotations of the loosening stage. As described hereinabove, the loosening direction of rotation can be the counter-clockwise or clockwise direction of rotation. The loosening stage number revolutions can, e.g., be a fraction of a revolution, half a revolution, a full revolution or more than one revolution of the fastening element, the tool holder or the output shaft. The rotational speed constancy or the maximum rotational speed can be set for the loosening stage rotational speed. It is conceivable that the loosening stage be performed as an optional method step.

Once the threading stage, the high-speed rotation stage, the cut-off stage, and/or the loosening stage have been set using the program, these stages can be transferred from the program to the hand-held power tool as the operating stage.

The present invention is also based on a control unit configured to perform the method described hereinabove. The control unit can be designed as at least one microprocessor and/or as at least one microcontroller.

The invention also describes a hand-held power tool, in particular a cut-off screwdriver, with a drive motor as described above and with a control unit as described hereinabove, which is designed to perform the method described above.

### BRIEF DESCRIPTION OF THE DRAWINGS

The invention is explained in more detail in the following with reference to a preferred embodiment. The drawings hereinafter show:

FIG. 1 a schematic view of a hand-held power tool;

FIG. 2 a flow chart of a method according to the invention for controlling the Hand-held power tool;

### DESCRIPTION OF THE EXEMPLARY EMBODIMENTS

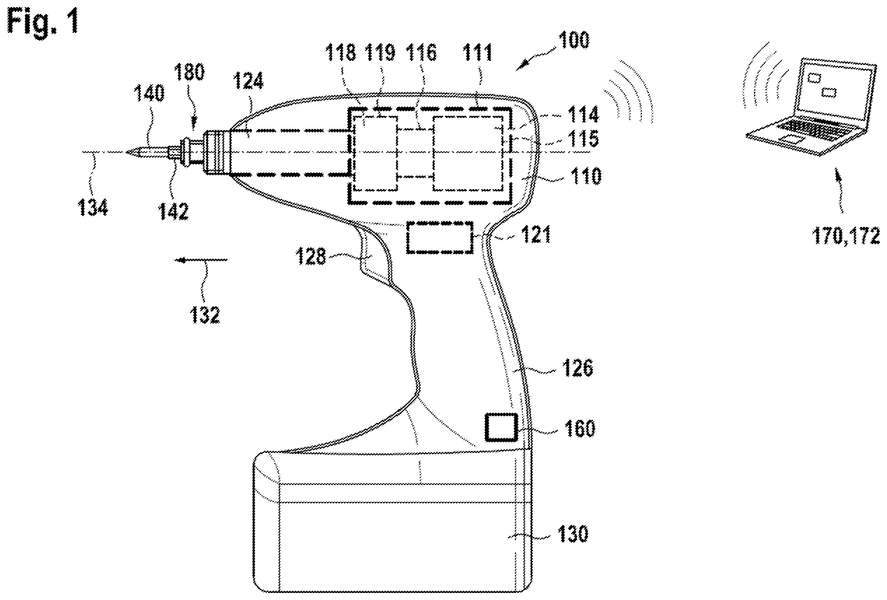

FIG. 1 shows a hand-held power tool 100 according to the invention, which is in this case designed as, e.g., a cut-off screwdriver. The hand-held power tool 100 comprises an output shaft 124, a tool holder 180, and a control unit 121. The hand-held power tool 100 comprises a housing 110 with a handle 126. Given a grid-independent current supply, the hand-held power tool 100 can be mechanically and electrically connected to an energy supply for battery operation, so the hand-held power tool 100 is designed as a battery-driven hand-held power tool 100. A hand-held power tool rechargeable battery pack 130 is in this case used as the energy supply. The present invention is not limited to battery-driven hand-held power tools, however, but can also be used for grid-dependent, i.e., grid-powered, hand-held power tools or pneumatically operated hand-held power tools.

By way of illustration, the housing 110 comprises a drive unit 111. The drive unit 111 further comprises an electric drive motor 114, which is supplied with current by the hand-held power tool rechargeable battery pack 130, and a transmission 118. The transmission 118 can be designed as at least one planetary gear. The drive motor 114 is designed such that it can be actuated, e.g. via a manual switch 128, so that the drive motor 114 can be switched on and off. The drive motor 114 can be any desired type of motor, e.g. an electronically commutated motor or a DC motor. The drive motor 114 can advantageously be electronically controlled and/or regulated so that a reversing mode and a desired rotational speed can be implemented. The design and mode of operation of a suitable drive motor are well known to the skilled person, for which reason they will not be described in greater detail herein. The hand-held power tool 100 comprises a tool axis 134. The tool axis 134 is in this case, by way of example, a rotational axis of the output shaft 124. In particular, the term “axial” is understood to mean essentially parallel to the tool axis 134, and “radial” is understood to mean essentially perpendicular to the tool axis 134.

The transmission 118 is connected to the drive motor 114 via a motor shaft 116. The transmission 118 is provided in order to convert a rotation of the motor shaft 116 into a rotation between the transmission 118 and the tool holder 180 via the output shaft 124. A motor housing 115 is, by way of illustration, associated with the drive motor 114. Similarly, a transmission housing 119 is associated with the transmission 118. Both the motor housing 115 and the transmission housing 119 are, by way of example, arranged inside the housing 110. However, it is also conceivable that the drive motor 114 and the transmission 118 can be arranged directly in the housing 110 if the hand-held power tool 100 is designed in an “open frame” design.

The tool holder 180 is provided on the output shaft 124. By way of example, the tool holder 180 is molded and/or formed on the output shaft 124. In this embodiment, the tool holder 180 is preferably arranged in an axial direction 132 facing away from the drive unit 111. Preferably, the output shaft 124 is designed to be integral with the tool holder 180. The tool holder 180 in this case comprises, by way of example, a polygonal internal holder for connection to a first insert tool 140. In this embodiment, the polygonal internal holder is shaped in the manner of a bit holder with an internal hexagon socket and is designed to receive the first insert tool 140 in the manner of a screwdriver bit. The first insert tool 140 comprises a suitable external hexagonal coupling 142 for this purpose. The type of the screwdriver bit, e.g. a HEX type, is sufficiently well-known to the skilled person. However, the present invention is not limited to the use of HEX screwdriver bits, but other first insert tools which appear useful to a skilled person can also be used, e.g. HEX drill bits or SDS-Quick insert tools. It is also conceivable that the tool holder 180 is designed as a polygonal external holder in the form of a square external holder.

The control unit 121 is in this case designed as a microprocessor. The control unit 121 controls and/or regulates the drive unit 111, in particular the drive motor 114. The control unit 121 is configured to perform a method 200 for controlling the hand-held power tool 100 when a user operates the manual switch 128. The control unit 121 is configured to set a rotational speed constancy of a rotational speed of the drive motor 114. The control unit 121 is further configured to operate the drive motor 114 depending on the set operating stage and/or the set rotational speed constancy. The control unit 114 is also configured to brake the drive motor 114 as soon as a cut-off criterion is met. The control unit 121 brakes the drive motor 114, e.g. by means of short-circuit brakes and/or counter-current brakes. It is possible that the control unit 121 be configured such that the control unit 121 switches off the drive motor 114 before braking and thereby de-energizes it.

The control unit 121 is designed to form a radio connection with an external communication device 170. The external communication device 170 is in this case designed, by way of example, as an external computing unit 170. The external computing unit 170 is in this case, by way of example, designed as a computer. The control unit 121 receives the method 200 for controlling the hand-held power tool by means of the wireless connection. Common wireless connections can in this case be Wi-Fi and/or Bluetooth connections. The hand-held power tool 100 comprises a USB interface 160. The USB interface 160 is wired to the control unit 121. The USB interface 160 enables a wired connection to be formed with the external unit 170. The control unit 121 can also receive the method 200 for control via the USB interface 160.

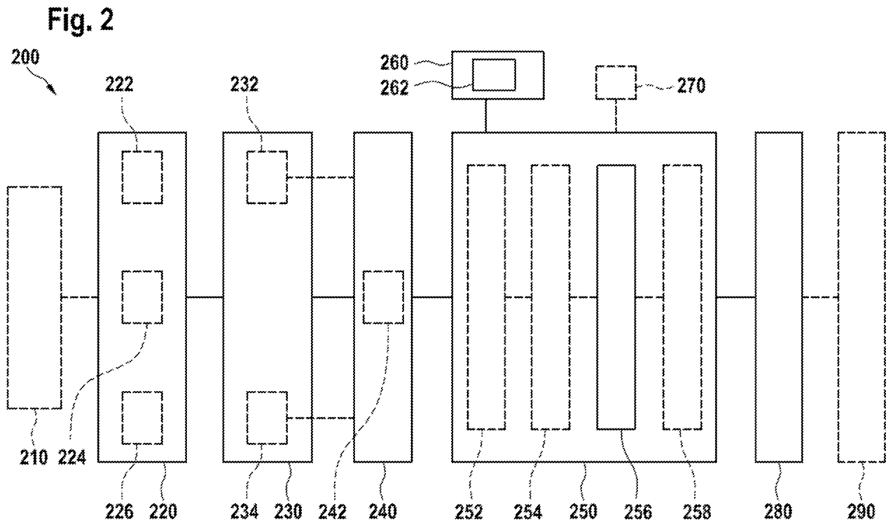

FIG. 2 shows a flow diagram of the method 200 according to the invention for controlling the hand-held power tool 100, in particular the cut-off screwdriver. In an optional upstream method step 210 an operating stage 202 is received from the external communication device 170 using the control unit 121. The operating stage 202 is received in a wired and/or wireless manner from the external communication device 170. Receiving the operating stage 202 essentially once can in this case be sufficient to operate the hand-held power tool 100. The control unit 121 can store the received operating stage 202.

The method step 210 of receiving the operating stage 202 is followed by a method step 220 in which the operating stage 202 is set for controlling the drive motor 114 by means of the control unit 121. The operating stage 202 features a rotational speed 222 of the drive motor 114, a rotational speed 224 of the drive motor 114, and a cut-off criterion 226. The direction of rotation 222 of the drive motor 114 is a loosening direction of rotation, e.g. a counterclockwise direction of rotation or a clockwise direction of rotation, or a tightening direction of rotation, e.g. a clockwise direction of rotation or a counterclockwise direction of rotation. The direction of rotation 222 is adjustable for each operating stage 202. The rotational speed 224 of the drive motor 114 is a rotational speed of an output shaft of the drive motor 114. The rotational speed 224 of the drive motor 114 is adjustable for each operating stage 202. The cut-off criterion 226 is set by the control unit 121. The cut-off criterion 226 features a criterion at which the hand-held power tool 100, in particular the cut-off screwdriver, switches off. The cut-off criterion 226 can be set for each operating stage 202.

Method step 220 is followed by method step 230, in which a rotational speed constancy of the rotational speed 224 of the drive motor 114 is set. In method step 232, the rotational speed constancy is activated so that the rotational speed 224 is essentially a rotational speed constancy. The rotational speed constancy can be set for each operating stage 202 . . . . The essentially constant rotational speed is in the range from 2,400 l/min to 24,000 l/min. The rotational speed constancy comprises a rotational speed fluctuation around the set rotational speed in the range of 10%. In method step 234, the rotational speed constancy is deactivated, so that the rotational speed 224 is a maximum rotational speed. The maximum rotational speed is the maximum speed of the drive motor 114. The maximum rotational speed depends on the current battery voltage of the hand-held power tool rechargeable battery pack 130. The maximum rotational speed can range from 9,000 l/min to 30,000 l/min and can be set for each operating stage 202.

Method step 230 is followed by method step 240, in which a battery voltage of the hand-held power tool rechargeable battery pack 130 of the hand-held power tool 1ßß is determined by means of the control unit 121. The control unit 121 is configured to determine the battery voltage before and/or during operation of the hand-held power tool 100. The control unit 121 can thus determine the battery voltage during each operating stage 202. Method step 240 comprises method step 242, in which a comparison of the battery voltage with a battery voltage limit value and a transmission of a number of screw connections is performed if the battery voltage falls below the battery voltage limit value. The control unit 121 is configured to compare the determined battery voltage with the battery voltage limit value when the battery voltage falls below the battery voltage limit value. The control unit 121 is configured such that a remaining number of screw connections is determined on the basis of the comparison of the battery voltage with the battery voltage limit value. The control unit 121 then transmits the remaining number of screw connections as the number of screw connections to the user using an output unit of the hand-held power tool 100.

Method step 240 is followed by method step 250, during which the drive motor 114 is operated depending on the set operating stage 202 and/or the set rotational speed constancy. Method step 250 can comprise an optional method step 252, in which operating stage 202 comprises a threading stage 203. In threading stage 203, at least half a revolution is performed in the loosening direction of rotation. The rotational speed constancy can be activated or deactivated in threading stage 203. Method step 250 comprises an optional method step 254, in which the operating stage 202 comprises a high-speed rotation stage 204. In the high-speed rotation stage 204, a high-speed rotation stage number of revolutions is performed in the tightening direction at a high-speed rotation stage speed. The high-speed rotation stage 204 can follow the threading stage 203. The high-speed rotation stage 204 features the high-speed rotation stage number of revolutions as the cut-off criterion 226. The rotational speed constancy can be activated or deactivated at the high-speed rotation stage speed. Method step 250 comprises method step 256, in which the operating stage 202 comprises a cut-off stage 205. In the cut-off stage 206, a cut-off stage rotational speed is performed in the tightening direction of rotation until a cut-off torque is reached as the cut-off criterion 226. Cut-off stage 205 can follow threading stage 203 and/or high-speed rotation stage 204. Rotational speed constancy can be activated or deactivated for the cut-off stage rotational speed. The cut-off stage rotational speed is in a range from 50 l/min to 3000 l/min. The method step 250 can comprise an optional method step 258, in which the operating stage 202 comprises a loosening stage 206. In loosening stage 206, a release stage number of revolutions is performed in the release direction of rotation. Loosening stage 206 can follow the cut-off stage 205. As the cut-off criterion 226, the loosening stage 206 comprises the loosening stage number of revolutions. The rotational speed constancy can be activated or deactivated at the loosening stage rotational speed.

In method step 260, the method 200 comprises method step 260, in which a current rotational speed of the drive motor 114 is detected using the control unit 121 and the current rotational speed is compared to the rotational speed 224. The control unit 121 is configured to detect the current rotational speed of the drive motor 114 and compare it to the rotational speed 224. Method step 260 comprises method step 262, in which the current rotational speed is controlled by means of the control unit 121 if the comparison results in a deviation from the current rotational speed to the rotational speed 224. The control unit 121 is configured such that the control unit 121 can control the current rotational speed during each operating stage 202, e.g., the threading stage 203, the high-speed rotation stage 204, the cut-off stage 205, and/or the loosening stage 206. The control unit 121 is additionally configured such that the current rotational speed is controlled at the deviation such that the rotational speed 224 is detected.

Method 200 comprises an optional method step 270, in which the battery voltage is compared with a battery voltage lower limit. If the battery voltage falls below the battery voltage lower limit, the cut-off criterion 226 is set for the operating stage 202 currently being performed. The control unit 121 is configured such that the control unit 121 can compare the battery voltage to the battery voltage lower limit and set the cut-off as the cut-off criterion 226. The control unit 121 then prevents further screwdriving.

Method step 250 is followed by method step 280, in which the drive motor 114 is braked when the cut-off criterion 226 is reached. As described hereinabove, the control unit 121 is configured such that the control unit 121 brakes the drive motor 114 by means of short circuit braking and/or counter-current braking. Method step 280 is followed by an optional method step 290, in which screw connection information is transmitted when the cut-off criterion 226 is reached. The screw connection information indicates whether a screw connection is satisfactory or not satisfactory. The screw connection information is transmitted to the output unit so that the output unit displays it to the user.

1. A method for controlling a hand-held power tool, the hand-held power tool including a drive motor and a control unit, the method comprising:
setting an operating stage for controlling the drive motor by way of the control unit, wherein the operating stage includes a direction of rotation of the drive motor, a rotational speed of the drive motor, and a cut-off criterion,
setting a rotational speed constancy of the rotational speed of the drive motor,
operating the drive motor depending on the set operating stage and/or the set rotational speed constancy, and
braking the drive motor when the cut-off criterion is met.

2. The method according to claim 1, wherein the rotational speed is essentially a constant rotational speed when the rotational speed constancy is activated.

3. The method according to claim 1, wherein the rotational speed is a maximum rotational speed when the rotational speed constancy is deactivated.

4. The method according to claim 1, further comprising detecting a current rotational speed of the drive motor by way of the control unit and comparing the current rotational speed with the rotational speed.

5. The method according to claim 4, wherein the current rotational speed is controlled by way of the control unit if the comparison results in a deviation by the current rotational speed from the rotational speed.

6. The method according to claim 1, further comprising:
receiving an operating stage from an external communication device by way of the control unit.

7. The method according to claim 1, further comprising:
transmitting screw connection information when the cut-off criterion is reached.

8. The method according to claim 1, further comprising:
determining a battery voltage of a hand-held power tool rechargeable battery pack of the hand-held power tool by way of the control unit.

9. The method according to claim 8, further comprising comparing the battery voltage to a battery voltage limit value, and transmitting a screw connection number when the battery voltage falls below the battery voltage limit value.

10. The method according to claim 1, wherein:
the operating stage comprises a threading stage, and
in the threading stage, at least a fraction of a revolution is performed in a loosening direction of rotation.

11. The method according to claim 1, wherein:
the operating stage comprises a high-speed rotation stage, and
in the high-speed rotation stage, a high-speed rotation stage number of revolutions is performed in a tightening direction of rotation at a high-speed rotation stage speed.

12. The method according to claim 1, wherein:
the operating stage comprises a cut-off stage, and
in the cut-off stage, a cut-off stage rotational speed is performed in a tightening direction of rotation until a cut-off torque is met as the cut-off criterion.

13. The method according to claim 1, wherein:
the operating stage comprises a loosening stage, and
in the loosening stage, a loosening stage number of revolutions is performed in a loosening direction of rotation.

14. A control unit, which is configured to perform the method according to claim 1.

15. A hand-held power tool, comprising:
a drive motor, and
a control unit which is designed to perform the method according to claim 1.

16. The method according to claim 1, wherein the hand-held power tool is a cut-off screwdriver.

17. The hand-held power tool according to claim 15, wherein the hand-held power tool is a cut-off screwdriver.
